(19) United States
(12) Patent Application Publication
(10) Pub. No.: US 2022/0215322 A1
(43) Pub. Date: Jul. 7, 2022

(54) METHOD FOR ALLOWING WORKER TO DO JOB AND APPARATUS THEREOF

(71) Applicant: Coupang Corp., Seoul (KR)

(72) Inventors: Myung Soo SONG, Seoul (KR); Ji Eun KIM, Seoul (KR); Hyeon A HA, Seoul (KR)

(21) Appl. No.: 17/166,873

(22) Filed: Feb. 3, 2021

(30) Foreign Application Priority Data
Jan. 4, 2021 (KR) 10-2021-0000339

(51) Int. Cl. G06Q 10/06; G06F 16/332

(52) U.S. Cl. CPC G06Q 10/063112; G06Q 10/06312; G06F 16/3329; G06Q 10/063114

(57) ABSTRACT

According to an example embodiment, a method of allowing a worker to perform a job includes receiving job starting information of the worker, transmitting query information on the job based on the job starting information, receiving answer information corresponding to the query information, and determining whether the worker performs the job in a predetermined manner based on the answer information. According to another example embodiment, an apparatus for performing the above method may be provided. A computer-readable recording medium on which a computer program to perform the above method according to another example embodiment is stored may be provided.

### BACKGROUND

### Technical Field

The present disclosure relates to a method and apparatus for determining whether to allow a worker to perform a job based on acquiring answer information on the job that the worker intends to perform.

### Description of the Related Art

As E-commerce is implemented in earnest and many users purchase items through the Internet, workers may perform various jobs that are performed in the process of loading and moving the items into warehouses for sales and shipment processes of the items.

Various jobs for managing items loaded in warehouses may be performed using various types of terminals carried by workers.

A terminal carried by a worker is interlocked with a distribution center management system, and thus the terminal carried by the worker and the management system may communicate with each other.

In the past, job management in a distribution center has been performed by a manager receiving various types of information on items that a worker may need to check in relation to each job while the worker performs the various jobs and manages the results. However, as E-commerce becomes more active, jobs may be performed in a wider variety of fields, such as logistics management, compliance with safety rules, progress of training programs, and inventory management. Therefore, since the types of information received from workers that may be managed by the management system become very complex and diversified, the load of the management job through the management system is becoming more severe. Accordingly, there is a need for a worker to report jobs and a manager to manage the jobs through efficient and uniform management of job-related information between a worker terminal and a distribution center management system.

### SUMMARY

### Technical Goals

The present disclosure is for efficiently managing information transmitted and received between a worker terminal and a management system to efficiently manage jobs performed in a distribution center.

The present disclosure is for a manager to efficiently inform a worker of information such as rules that the worker needs to observe at a job site or educational materials that the worker may need to be aware of

Objects that may be derived through the following example embodiments are not limited to the above-described objects, and other objects and advantages that are not described may be understood from the following description and will be more clearly understood from example embodiments. In addition, it may be easily appreciated that the objects and advantages the may be derived through the example embodiments may be realized by means described in the claims and combinations thereof.

### Technical Solutions

According to an aspect, there is provided a method of allowing a worker to perform a job, the method including receiving job starting information of the worker, transmitting query information on a job based on the job starting information, receiving answer information corresponding to the query information, and determining whether the worker is to perform the job in a predetermined manner based on the answer information.

The method of allowing a worker to perform a job may further include transmitting approval information indicating whether the worker is to start the job based on the determining.

The transmitting of the approval information may include transmitting the approval information indicating that the worker is not allowed to perform the job when it is determined that the worker is not performing the job in the predetermined manner.

The determining may include determining whether at least one of the answer information matches predetermined answer information, and the transmitting of the approval information may include transmitting the approval information indicating that the worker is not allowed to perform the job when the at least one of the received answer information matches a predetermined answer.

The method of allowing a worker to perform a job may further include modifying at least one of the query information or the predetermined answer information.

The transmitting of the query information may further include transmitting the query information including a request for image information.

The transmitting of the query information may include determining at least one of query information to be transmitted from among predetermined query information based on the received job starting information.

The transmitting of the query information may further include determining additional query information to be additionally transmitted based on the received answer information.

The receiving of the job starting information may include receiving the job starting information including at least one of an identifier of the worker, an identifier of the job, or an identifier of a workplace where the job is performed.

According to another aspect of the present disclosure, there is also provided an apparatus for allowing a worker to perform a job, the apparatus including a transceiver configured to receive job starting information of the worker, transmit query information on a job based on the received job starting information, and receive answer information corresponding to the query information, and a processor configured to determine whether the worker is to perform the job in a predetermined manner based on the answer information.

The transceiver may be further configured to transmit approval information indicating whether the worker is to start the job based on the determination.

The transceiver may be configured to transmit the approval information indicating that the worker is not allowed to perform the job when the worker is not performing the job in the predetermined manner.

The processor may be configured to determine whether at least one of the received answer information matches predetermined answer information, and the transceiver may be configured to transmit the approval information indicating that the worker is not allowed to perform the job when the at least one of the received answer information matches the predetermined answer information.

The processor may be further configured to modify at least one of the query information or the predetermined answer information.

The transceiver may be configured to transmit the query information including a request for image information.

The transceiver may be configured to determine at least one of query information to be transmitted from among predetermined query information based on the received job starting information.

The transceiver may be further configured to determine additional query information to be additionally transmitted based on the received answer information.

The transceiver may be configured to receive the job starting information including at least one of an identifier of the worker, an identifier of the job, or an identifier of a workplace where the job is performed.

According to another aspect of the present disclosure, there is also provided a non-transitory computer readable recording medium on which a computer program to execute a method of allowing a worker to perform a job is stored.

### Effects

According to various example embodiments provided in the present disclosure, it is possible to efficiently manage the jobs performed in the distribution center by efficiently managing the information transmitted and received between the worker terminal and the management system.

According to various example embodiments provided in the present disclosure, it is possible for the manager to efficiently manage the jobs performed in the workplace by directly or indirectly forcing the worker to comply with the rules that may need to be observed in performing the jobs in the workplace.

In addition to the above-described effects, specific effects that can be derived have been given in the detailed description of the present disclosure.

### BRIEF DESCRIPTION OF THE DRAWINGS

FIG. 1 is a block diagram of an apparatus according to an example embodiment.

FIG. 2 is a flowchart of a method according to an example embodiment.

FIGS. 3 and 4 are diagrams for describing a flow of information transmitted and received between the apparatus according to the example embodiment and a worker terminal.

FIGS. 5A and 5B are diagrams for describing a process of generating job starting information in the worker terminal and generating answer information by receiving query information according to an example embodiment.

FIGS. 6, 7A, and 7B are diagrams for describing a process of modifying and/or storing the query information displayed on the worker terminal according to an example embodiment.

FIG. 8 is a diagram for describing additional query information that may be additionally provided according to answer information of a worker according to an example embodiment.

### DETAILED DESCRIPTION

Hereinafter, example embodiments will be described in detail with reference to the accompanying drawings so that those with ordinary skill in the technical field can easily implement the example embodiments. The following example embodiments may be implemented in various different forms and are not limited thereto.

The suffix “units” for components used in the following description is given or mixed in consideration of only the ease of writing of the specification, and therefore, does not have a meaning or role that distinguish components from each other in itself

For clear description, parts irrelevant to the description are omitted, and the same reference numerals are attached to the same or similar components throughout the specification. In addition, some example embodiments will be described in detail with reference to exemplary drawings. In adding reference numerals to components of each drawing, the same components will be denoted by the same reference numerals even when they are illustrated in different drawings. In addition, in describing the present disclosure, when it is determined that a detailed description of related known configurations or functions may obscure the gist of the example embodiments, such detailed description may be omitted.

The terms “first,” “second,” “A,” “B,” “(a),” “(b),” and the like may be used in describing components of example embodiments. These terms are used only in order to distinguish the components from other components, and the nature, sequence, order, or the like of the corresponding components is not limited by these terms. When it is stated that any components are “coupled,” “combined,” or “connected” to each other, it is to be understood that the components may be directly coupled or connected to each other, another component may be “interposed” between the components, or the components may be “combined” or “connected” to each other through another component.

It should be understood that the terms “include,” “comprise,” “have,” or the like used in the present disclosure specify the presence of stated features, numerals, steps, operations, components, and parts described in this specification, or a combination thereof, but do not preclude the possibility of presence or addition of one or more other features, numerals, steps, operations, components, parts, or a combination thereof.

In addition, in implementing the present disclosure, components may be described in subdivisions for convenience of description, but these components may be implemented in one device or module, or one component may be implemented by being divided into a plurality of devices or modules.

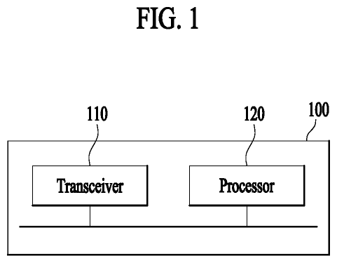

FIG. 1 is a block diagram of an apparatus 100 for allowing a worker to perform a job according to an example embodiment.

According to an example embodiment, the apparatus 100 may include a transceiver 110 configured to receive job starting information of a worker, transmit query information on a job based on the received job starting information, and receive answer information corresponding to the query information and a processor 120 configured to determine whether a worker is to perform the job in a predetermined manner based on the answer information.

According to an example embodiment, the transceiver 110 may be configured to transmit and receive predetermined types of information in connection with a worker terminal. According to an example embodiment, communication technologies used by the transceiver 110 may include Global System for Mobile Communications (GSM), code division multi access (CDMA), Long Term Evolution (LTE), 5G, a wireless LAN (WLAN), wireless-fidelity (Wi-Fi), Bluetooth™, radio frequency identification (RFID), Infrared Data Association (IrDA), ZigBee, near field communication (NFC), and the like.

According to an example embodiment, the processor 120 may be included in the apparatus 100 to control various components included in the apparatus 100 to perform various example embodiments that may be implemented by the apparatus 100. According to an example embodiment, the transceiver 110 may be configured to transmit and receive predetermined information by being controlled by the processor 120.

According to an example embodiment, the processor 120 may include at least one of a random access memory (RAM), a read-only memory (ROM), a central processing unit (CPU), a graphics processing unit (GPU), or a bus, which may be connected to each other. According to an example embodiment, the processor 120 may be configured to access a memory included in the apparatus 100 and perform various operations using various programs, data, and predetermined types of information stored in the memory.

According to an example embodiment, the apparatus 100 may be configured to perform various operations in connection with additional hardware in addition to the components illustrated in FIG. 1. According to an example embodiment, the apparatus 100 may further include a memory which stores information transmitted and received by the transceiver 110. According to an example embodiment, the apparatus 100 may include (or may be connected to in a wired/wireless manner) a display that is controlled by the processor 120 to display predetermined information, and according to the example embodiment of the present disclosure, the processor 120 may output at least some of various pieces of transmitted and received information to the display, and the manager may receive the transmitted and received information in relation to the worker terminal.

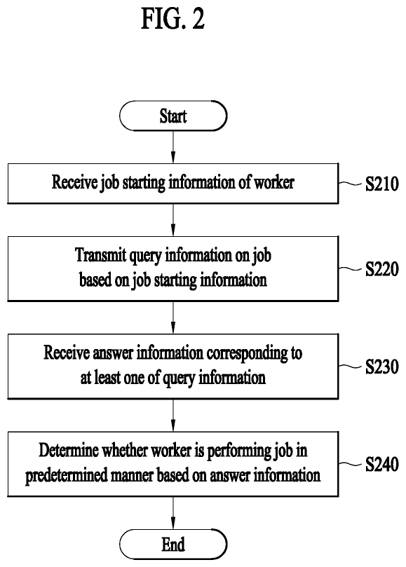

FIG. 2 is a flowchart of a method according to an example embodiment. The flowchart illustrated in FIG. 2 relates to a method that may be performed by the apparatus 100.

In operation S210, the transceiver 110 may receive job starting information of a worker according to an example embodiment. According to an example embodiment, the transceiver 110 may receive the job starting information from a terminal of a worker, and the processor 120 may start performing the method presented in the present disclosure based on the reception of the job starting information. According to an example embodiment, the job starting information may include information that a worker starts any of various types of jobs (for example, driving of a forklift, a truck, a two-wheeled vehicle, or the like, participation in training, a maintenance job, a logistics transport job, and the like) that may be performed at a workplace. According to an example embodiment, the job starting information may include at least one of various types of information related to a job to be performed, such as an identifier of a worker, an identifier of a job, a location where the job is to be performed, a time in which the job is to be performed, or the worker for the job.

According to an example embodiment, a worker may automatically transmit the job starting information to the apparatus 100 by performing a predetermined operation on a job to be performed using a terminal. According to an example embodiment, a worker may photograph a code such as a barcode or a QR code attached to a location where a job is to be performed as a predetermined operation using a terminal, and thus the apparatus 100 may receive the job starting information from the worker terminal. According to an example embodiment, a worker may generate the job starting information based on information input through a terminal in various ways.

In operation S220, the transceiver 110 may transmit query information on a job to the worker terminal based on the job starting information received in operation S210 according to an example embodiment. According to an example embodiment, the query information transmitted by the transceiver 110 may include at least one query. According to an example embodiment, the processor 120 may determine query information, which is related to a job to be started by a worker based on at least one of information included in the received job starting information, and control the transceiver 110 to transmit such query information to the worker terminal. According to an example embodiment, the processor 120 may identify a job that a worker intends to perform based on the information (for example, job identifier) included in the job starting information, determine query information on the identified job, and control the transceiver 110 to transmit the determined query information to the worker terminal.

According to an example embodiment, the apparatus 100 may store a preset job to be performed by any worker. According to an example embodiment, when the identifier of the worker is included in the job starting information received by the apparatus 100, the apparatus 100 may identify a job that a worker intends to perform based on the identifier of the worker and the preset job, determine query information on the identified job, and control the transceiver 110 to transmit the determined query information to the worker terminal.

According to an example embodiment, the apparatus 100 may set and store a location where a job is to be performed in advance. According to an example embodiment, the job starting information may include information indicating a location where a job is to be performed, and the processor 120 may identify a job that a worker intends to perform based on the information on the location where the job is to be performed, which is included in the job starting information, determine query information on the identified job, and control the transceiver 110 to transmit the determined query information to the worker terminal.

According to an example embodiment, the apparatus 100 may identify a job that a worker intends to perform by a worker by combining various pieces of information included in the job starting information and may transmit query information based on the identified job to the corresponding worker terminal.

In operation S230, the transceiver 110 may receive answer information corresponding to the query information according to an example embodiment. According to an example embodiment, the transceiver 110 may receive, from the worker terminal, the answer information created by the worker based on the query information transmitted to the worker terminal by the transceiver 110.

According to an example embodiment, the answer information may include information on various forms and content requested by the query information, such as text information, image information, audio information, video information, and information indicating which answer is selected from multiple options, which is created by a worker in response to a query requested for the query information.

In operation S240, the processor 120 may determine whether a worker is performing a job in a predetermined manner based on the answer information received in operation S230 according to an example embodiment. According to an example embodiment, the processor 120 may set the answer information corresponding to the query information transmitted in operation S220 in advance. According to an example embodiment, the processor 120 may determine whether the answer information corresponding to the query information and the answer information received in operation S230 match each other by comparing the answer information corresponding to the query information with the answer information received in operation S230. According to an example embodiment, when it is determined that the answer information corresponding to the query information and the answer information received in operation S230 match each other by comparing the answer information corresponding to the query information with the answer information received in operation S230, the processor 120 may determine that a worker performs a job in a predetermined manner. According to an example embodiment, when it is determined that the answer information corresponding to the query information and the answer information received in operation S230 do not match each other by comparing the answer information corresponding to the query information with the answer information received in operation S230, the processor 120 may determine that a worker does not perform a job in a predetermined manner.

According to an example embodiment, when the processor 120 determines that a worker does not perform a job in a predetermined manner, the processor 120 may determine additional query information to be transmitted to the worker terminal. According to an example embodiment, the additional query information is related to query information corresponding to the answer information determined not to match and may be included in at least one of preset query information.

According to an example embodiment, the processor 120 may generate approval information indicating whether a worker may start the corresponding job based on the determination on whether the worker performs the job in the predetermined manner and transmit the approval information to the worker terminal. According to an example embodiment, the processor 120 is configured to determine whether at least one of the answer information matches a predetermined answer, and the transceiver 110 may be configured to transmit the approval information indicating that the worker is not allowed to perform the job when at least one of the answer information matches the predetermined answer. According to an example embodiment, the apparatus 100 may store at least one of answer information determined to correspond to the query information in advance, and transmit the information for not approving the worker to perform the job to the worker terminal by comparing received answer information with the predetermined answer information.

For example, when a worker transmits job starting information to the apparatus 100 to start a forklift driving job and transmits answer information for at least one of query information related to the forklift driving job, the processor 120 may identify the forklift based on the answer information and determine whether the forklift may be driven. When it is determined that the predetermined answer information indicating the state in which the forklift may not be driven and the received answer information match each other, the processor 120 may transmit the approval information indicating that the worker does not start driving the forklift to the worker terminal so that the worker does not drive the corresponding forklift. On the other hand, when it is determined that the predetermined answer information indicating the state in which the forklift may not be driven and the received answer information do not match each other, the processor 120 may transmit the approval information indicating that the worker is approved to drive the corresponding forklift to the worker terminal.

According to an example embodiment, the worker terminal may receive the approval information through the transceiver 110, determine whether to start a job that a worker intends to start based on the received approval information, and display the result. For example, a worker may transmit the job starting information to the apparatus 100 by photographing a QR code or the like attached to a forklift to start the forklift driving job, and then display whether or not the forklift may be driven based on the approval information received in response thereto.

According to an example embodiment, when a predetermined function provided by a terminal is set to be necessary for a worker to perform a job, the transceiver 110 may transmit the approval information to activate/deactivate a predetermined function to the worker terminal.

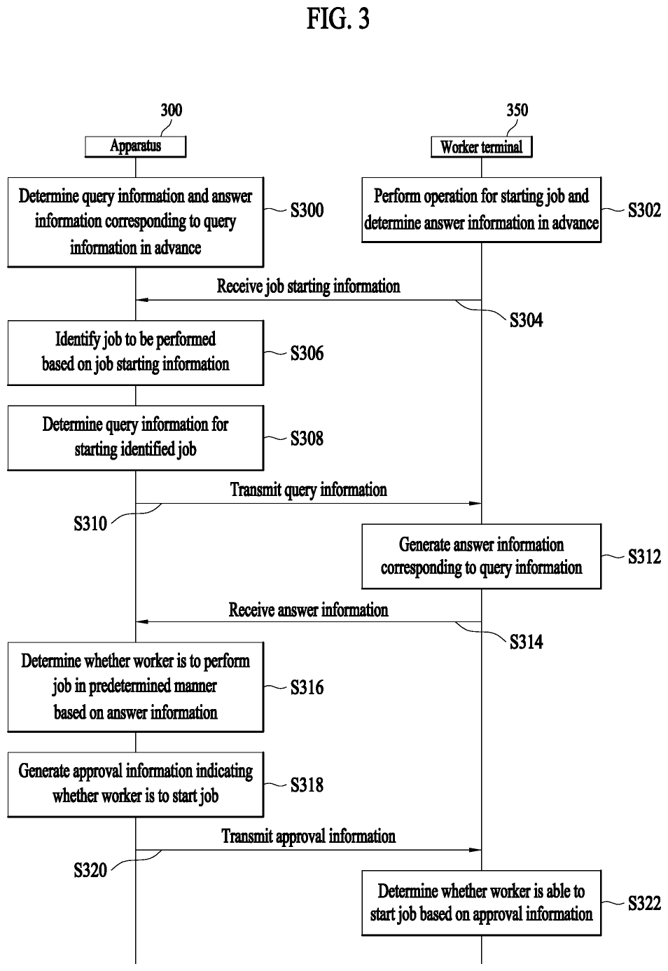

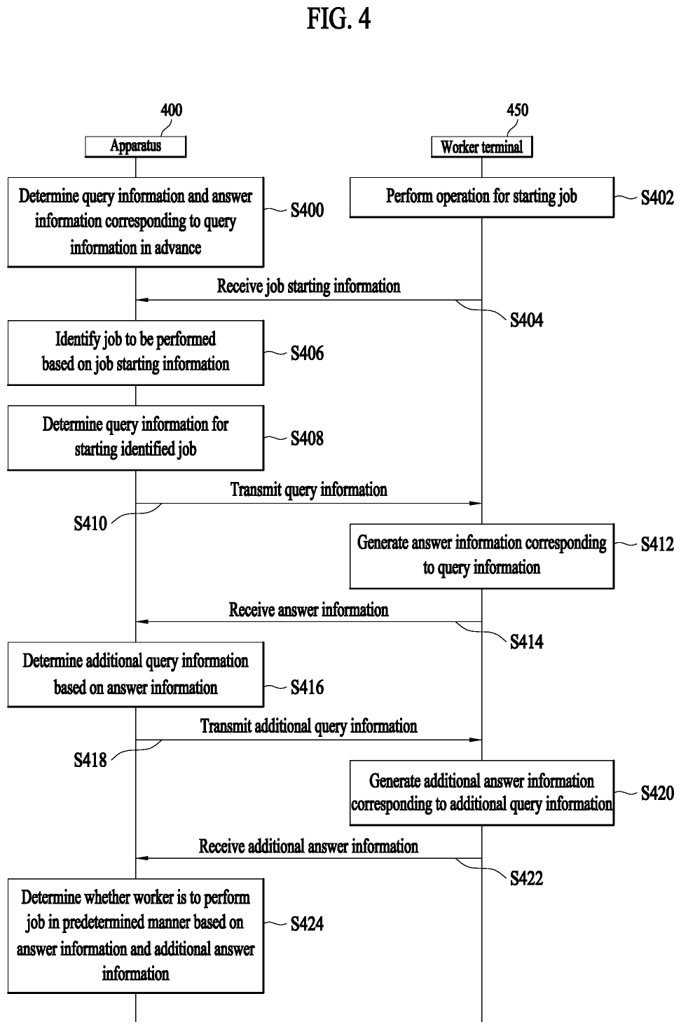

FIGS. 3 and 4 are diagrams for describing a flow of information transmitted and received between the apparatus according to the example embodiment and the worker terminal.

Referring to FIG. 3, job starting information, query information, answer information, and approval information may be transmitted and received between an apparatus 300 and a worker terminal 350.

According to an example embodiment, in operation S300, the apparatus 300 may determine query information and answer information corresponding to the query information in advance before operation S304 of receiving the job starting information and store the query information and answer information in the memory. According to an example embodiment, the query information and answer information determined and stored in advance may be set and stored to have a corresponding relationship based on at least one of a worker, a job, a location, or a time.

According to an example embodiment, in operation S302, a predetermined operation for a worker to perform a job may be performed through the worker terminal 350. For example, the worker terminal 350 may perform an operation of photographing a QR code or a barcode, a login operation, and the like as operations for a worker to start a job.

According to an example embodiment, in operation S304, the apparatus 300 may receive the job starting information from the worker terminal 350 through the result of the predetermined operation performed by the worker terminal 350. According to an example embodiment, the job starting information may include various types of information related to the operation performed in the worker terminal 350 in operation S302. For example, the job starting information may include at least one of an identifier of a worker, an identifier of a job, an identifier of the worker terminal 350, or information on a location and/or time where the job is to be performed.

According to an example embodiment, in operation S306, the apparatus 300 that has received the job starting information may identify a job to be performed based on the job starting information. According to an example embodiment, in operation S308, the apparatus 300 may identify what job the worker terminal 350 intends to perform by using various types of information included in the job starting information and the correlation between the information and may determine at least one of query information to be transmitted to the worker terminal 350 by selecting the query information for starting the identified job from among the predetermined query information in operation S300.

According to an example embodiment, when the determined query information is transmitted to the worker terminal in operation S310, the worker terminal 350 may generate the answer information corresponding to the query information in operation S312. According to an example embodiment, the answer information corresponding to the query information may be generated based on a signal input by a worker carrying the worker terminal 350. For example, the answer information may be generated based on at least one of various types of answer information such as text information, image information, video information, audio information, or location information input to the worker terminal 350. According to an example embodiment, the type of answer information requested by the worker terminal 350 may be a type corresponding to the query information transmitted in operation S310. According to an example embodiment, the transmitted query information may include requesting a worker to input predetermined text information through the worker terminal 350 as the answer information or requesting to acquire a predetermined image, video, audio, and the like. According to an example embodiment, when the answer information requested according to the transmitted query information corresponds to information that may be acquired without the input of the worker (for example, the location information of the worker terminal 350, the identifier of the worker terminal 350, or the like), even when the worker does not perform a predetermined operation for including the corresponding information in the answer information, the corresponding information may be transmitted to the apparatus 300 by being automatically included in the answer information.

According to an example embodiment, in operation S316, the apparatus 300 may determine whether a worker is to perform a job in a predetermined manner based on the answer information received in operation S314.

According to an example embodiment, the apparatus 300 may perform an operation of matching the answer information received in operation S314 with the answer information determined in advance in operation S300 to determine whether a worker performs a job in a predetermined manner. According to an example embodiment, the operation of matching the received answer information with the predetermined answer information may include performing various conventional matching operations, such as keyword analysis, natural language processing, image/video/audio processing and analysis, and location information analysis, which are included in the answer information.

According to an example embodiment, in operation S318, the apparatus 300 may determine whether to perform a job in a predetermined manner in operation S316, and generate approval information indicating whether a worker is to start a job based on the determination. According to an example embodiment, when it is determined that the received answer information and the predetermined answer information at least partially match each other, the apparatus 300 may determine that a worker does not perform a job in a predetermined manner and generate approval information indicating that the worker is not allowed to perform the job based on the determination. According to an example embodiment, when it is determined that the received answer information and the predetermined answer information do not match each other, the apparatus 300 may determine that a worker performs a job in a predetermined manner and generate approval information indicating that the worker is allowed to perform the job based on the determination.

According to an example embodiment, the apparatus 300 may transmit the approval information to the worker terminal 350 in operation S320, and the worker terminal 350 may determine whether a worker is able to start a job based on the received approval information in operation S322. According to an example embodiment, the worker terminal 350 may provide a worker with information on whether the corresponding job is approved to start by displaying whether the job can be started.

FIG. 4 illustrates a method further including a process of transmitting and receiving additional query information and additional answer information in addition to the method performed in FIG. 3. According to an example embodiment, an apparatus 400 and a worker terminal 450 of FIG. 4 may correspond to the apparatus 300 and the worker terminal 350 of FIG. 3. According to an example embodiment, the apparatus 400 may be configured to additionally perform at least some of the processes performed by the apparatus 300 of FIG. 3 among the processes not illustrated in FIG. 4.

According to an example embodiment, features of operations S400 to S414 of FIG. 4 may be the same as or similar to those of operations S300 to S314 of FIG. 3, and a detailed description thereof will be omitted.

According to an example embodiment, the apparatus 400 may determine additional query information based on the answer information received in operation S414. According to an example embodiment, a process of transmitting query information and receiving answer information corresponding to the query information between the apparatus 400 and the worker terminal 450 may be performed at least once. According to an example embodiment, when the answer information received from the worker terminal 450 satisfies a predetermined condition, the apparatus 400 may determine the additional query information based on the received answer information. For example, the predetermined condition for determining the additional query information may be whether the received answer information matches at least some of the answer information determined in advance in relation to the query information. According to an example embodiment, the apparatus 400 may map and store the additional query information corresponding to each piece of the predetermined answer information in relation to the query information. That is, the additional query information to be transmitted to the worker terminal 450 may vary depending on what the predetermined answer information matching the received answer information is.

According to an example embodiment, in operation S420, the worker terminal 450 receiving the additional query information may generate the additional answer information corresponding to the additional query information. The process of generating additional answer information in operation S420 may be the same as or similar to the process of generating answer information in operation S412, and therefore a detailed description thereof will be omitted.

According to an example embodiment, in operation S422, the apparatus 400 may receive additional answer information from the worker terminal 450 in response to transmitting additional query information in operation S418.

According to an example embodiment, in operation S424, the apparatus 400 may determine whether a worker performs a job in a predetermined manner based on the answer information received in operation S414 and the additional answer information received in operation S422. According to an example embodiment, a process of determining whether or not a worker performs a job in a predetermined manner in operation S424 may be the same as or similar to the process performed in operation S316, and therefore a detailed description thereof will be omitted.

According to an example embodiment, the apparatus 400 may generate approval information indicating whether a worker may start a job based on the determination in operation S424. According to an example embodiment, the apparatus 400 may transmit the approval information to the worker terminal 450, and the worker terminal 450 may determine whether a worker can start a job based on the received approval information.

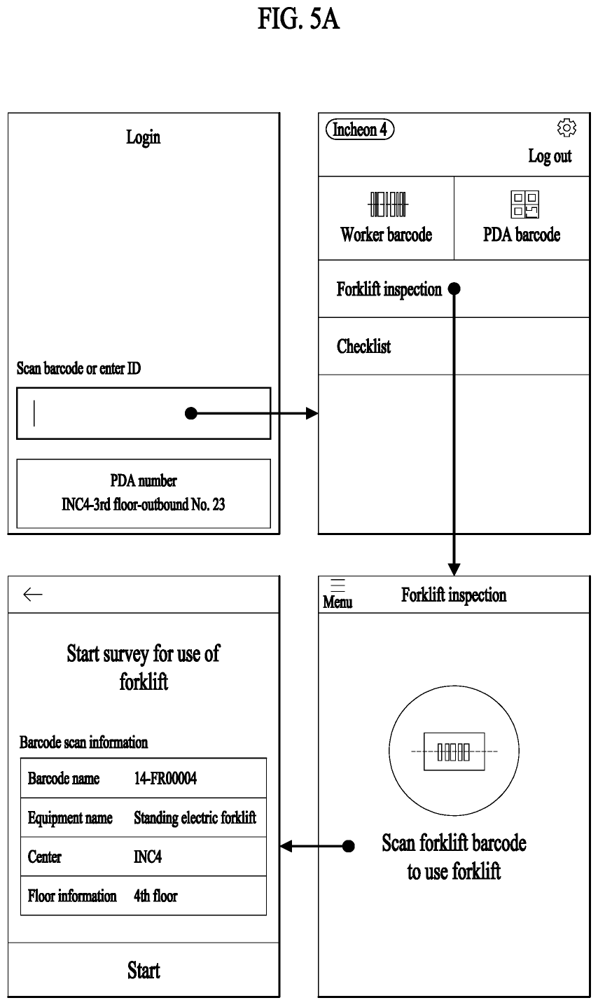

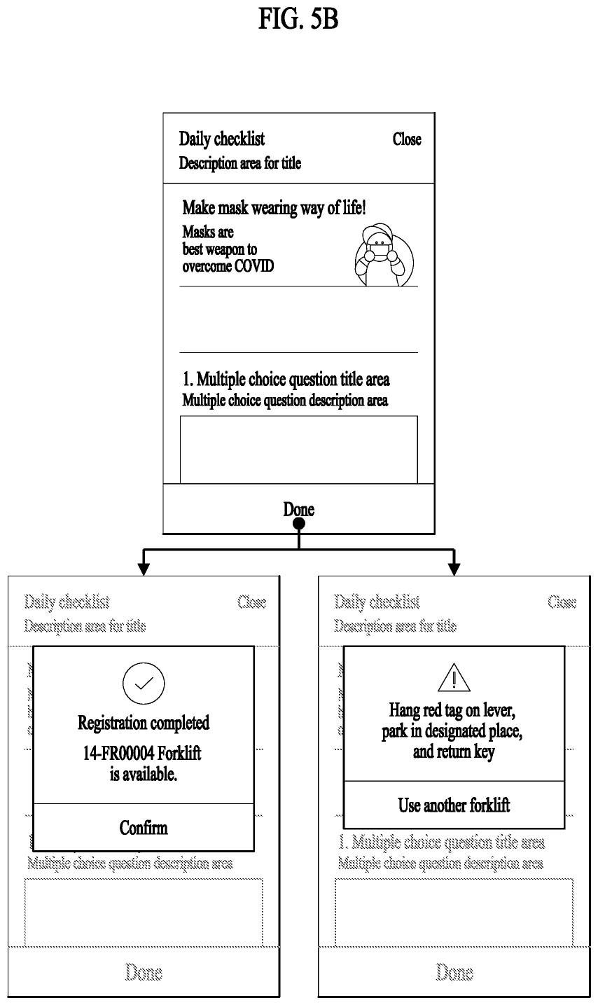

FIGS. 5A and 5B are diagrams for describing a process of generating job starting information in the worker terminal and generating answer information by receiving query information according to an example embodiment.

Referring to FIG. 5A, according to an example embodiment, the worker terminal may perform a job starting operation for performing a predetermined job at a workplace, and job starting information may be generated by the job starting operation.

According to an example embodiment, prior to starting a job, a worker may transmit information on at least one of an identifier of the worker, an identifier of the worker terminal, an identifier of a predetermined asset to be used for a job, location information, or time information to the apparatus 100 through the worker terminal. According to an example embodiment, a worker to start a job, a worker terminal, a location where the job is to be performed, and the like may be identified based on the information transmitted through the worker terminal, and such identified information may be displayed on the worker terminal. According to an example embodiment, in order to perform the identified job, a worker may perform a predetermined operation (for example, scanning a barcode of a worker, a barcode of a worker terminal, a barcode of a predetermined asset to be used for a job, and the like) using the worker terminal. Referring to FIG. 5A, in order for a worker to perform a forklift driving job, the worker may scan the barcode of the forklift using the worker terminal. According to an example embodiment, by scanning the barcode of the forklift, the worker terminal may acquire various types of information related to the forklift such as a barcode name, an equipment name, and device locations (center and floor). According to an example embodiment, the worker terminal may transmit, to the apparatus 100, the job starting information acquired by at least partially performing the above-described series of processes including scanning the acquired barcode of the forklift.

Referring to FIG. 5B, according to an example embodiment, the apparatus 100 may transmit the query information related to the corresponding job to the worker terminal based on the acquired job starting information. According to an example embodiment, when any object (for example, a start button) displayed on the worker terminal is selected, the job starting information may be transmitted to the apparatus 100, and the query information received as a response thereto may be displayed on the worker terminal. The worker terminal may generate answer information on queries related to forklift inspection based on the received query information. According to an example embodiment, the query information may include safety matters to be confirmed by a driver before the operation of the forklift is started.

According to an example embodiment, the answer information generated through the worker terminal may be transmitted to the apparatus 100 when any object (for example, a completion button) is selected.

According to an example embodiment, the apparatus 100 may transmit approval information indicating whether a worker may start a job based on the received answer information to the worker terminal.

According to an example embodiment, when it is determined that a worker may start a job according to the answer information, the approval information indicating that the start of the job to be performed by the worker is approved may be transmitted to the worker terminal.

According to an example embodiment, the apparatus 100 may determine that the job is performed by the worker and store the job while transmitting the approval information to approve the start of the job to the worker terminal. According to an example embodiment, when it is determined that a worker may not start a job according to the answer information, the approval information indicating that the start of the job to be performed by the worker is not approved may be transmitted to the worker terminal. The fact that the start of the job is not approved and, if not approved, an instruction (for example, hang a red tag on a lever, park in a designated location, and return a key) for a preset job process may be displayed on the worker terminal that has received the approval information indicating that the start of the job is not approved. According to an example embodiment, additional information to guide starting a job through another asset may be displayed on the worker terminal that has received the approval information indicating that the start of the job is not approved. According to an example embodiment, when the reason why the start of the job is not approved is that there is a problem with the asset, a worker may transmit only job starting information that changes only the asset to another asset to the apparatus 100, and therefore, when any object (for example, a button to use another forklift) provided on a screen indicating that the start of the job is not approved is selected, the generated job starting information (for example, using another forklift) may be transmitted to the apparatus 100 by performing the process of modifying only the information on the relevant asset through the worker terminal again.

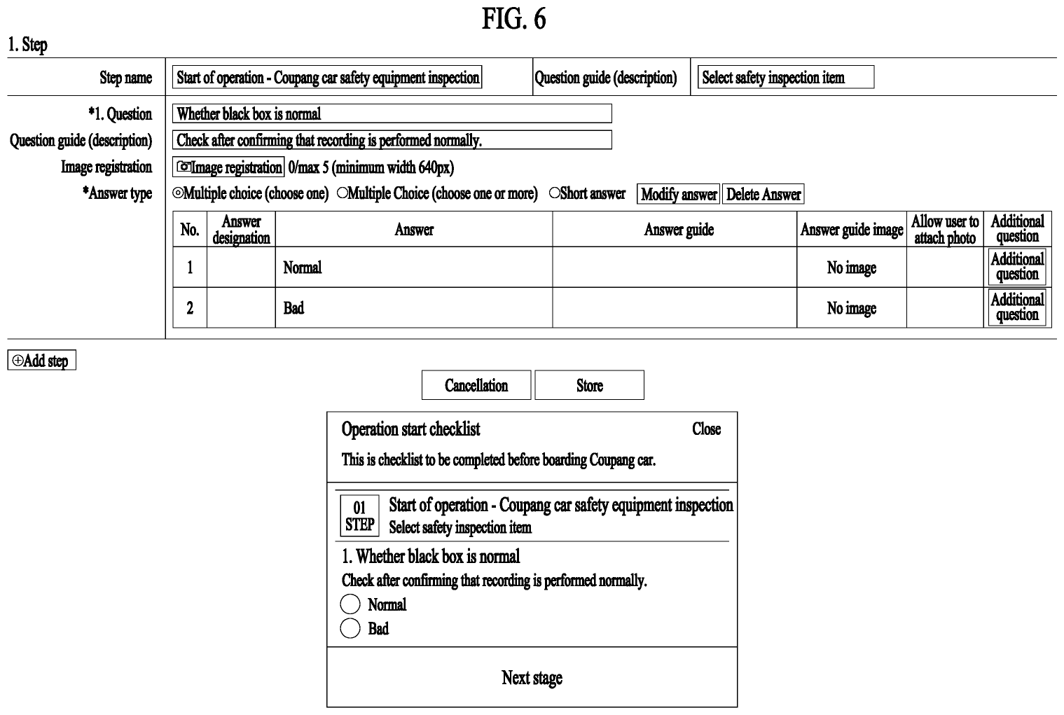

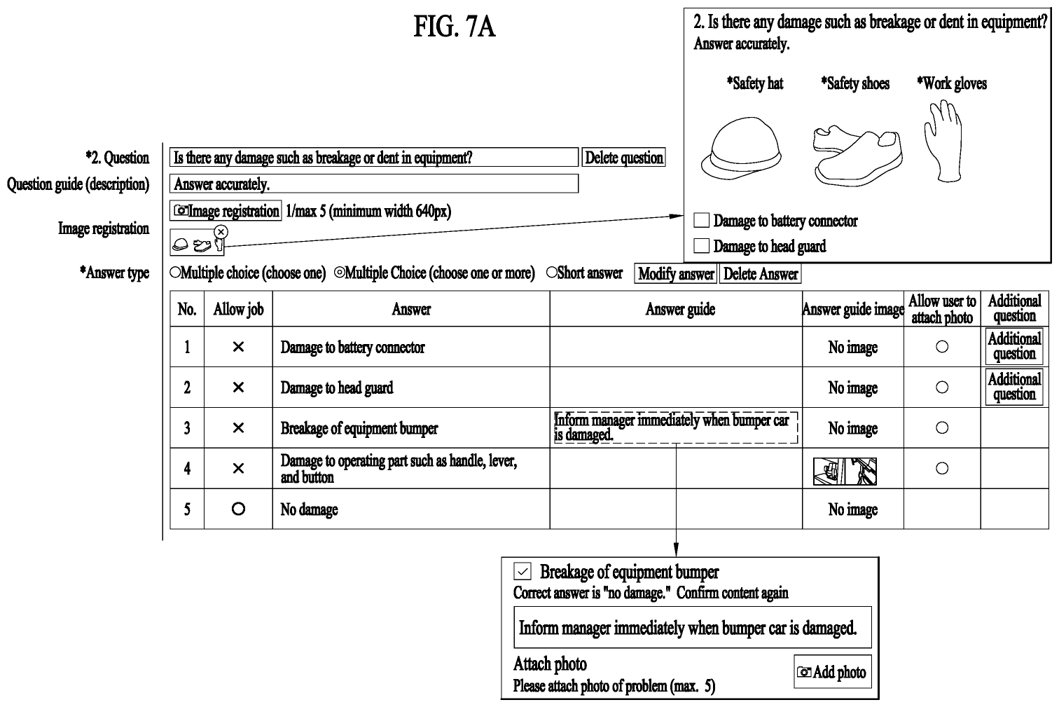

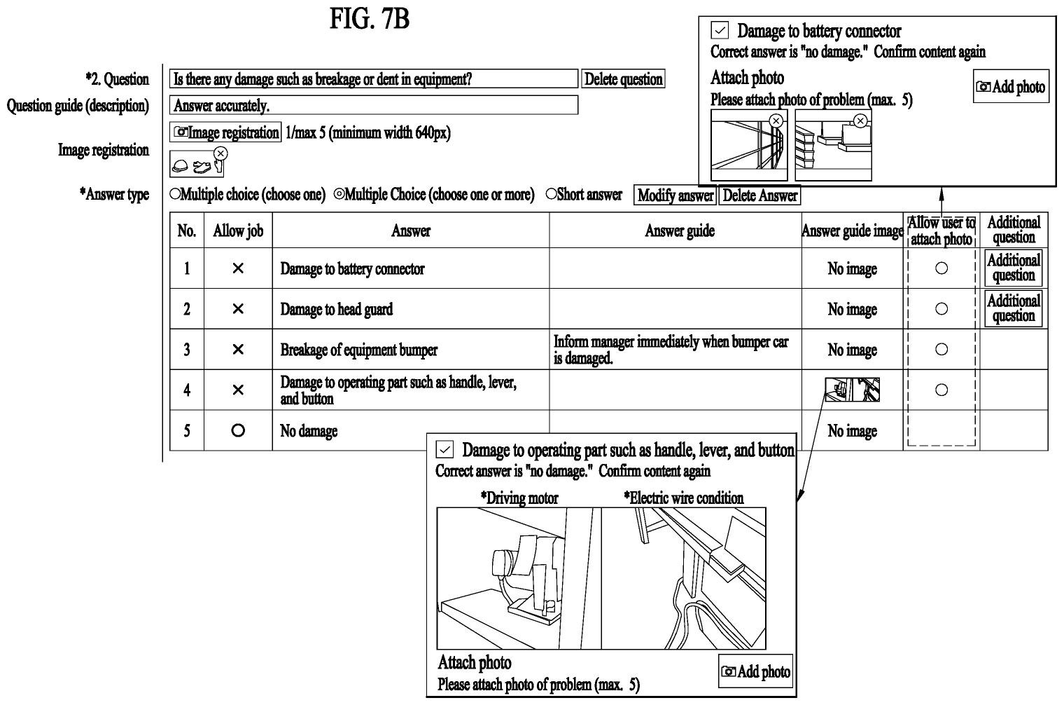

FIGS. 6, 7A, and 7B are diagrams for describing a process of modifying and/or storing query information displayed on a worker terminal according to an example embodiment.

According to an example embodiment, the apparatus 100 may determine and store query information corresponding to job starting information received by a worker terminal in advance. According to an example embodiment, the apparatus 100 may set, modify, and/or store at least one step to be performed in performing a job identified according to job starting information received by a worker terminal. According to an example embodiment, the pre-stored query information may be modified and/or stored as query information for each step for each job. According to an example embodiment, when the worker terminal displays query information for each step, the apparatus 100 may additionally display guide information on the corresponding step (for example, a step guide (description)). According to an example embodiment, as one of the steps of starting a forklift driving job, query information on the driving start step may be stored, and a description (for example, safety equipment inspection) related to the driving start step may be additionally displayed.

According to an example embodiment, the apparatus 100 may modify and/or store information to be displayed as the query information for each step. According to an example embodiment, there may be at least one of query information related to the step, and at least one of question content, question guide information, or related images for each piece of query information may be modified and/or stored as query information to be displayed on the worker terminal.

According to an example embodiment, the query information modified and/or stored by the apparatus 100 may be transmitted to the worker terminal as query information for each step for a job that a worker intends to perform. According to an example embodiment, the apparatus 100 may determine and store a format of the answer information for the query information in advance. According to an example embodiment, the query information may include a format for selecting one of a plurality of pre-selected options, a format including text information created by a worker, and a format for selecting an image as the format of the answer information to be created by the worker terminal and may be a combination of these various formats.

Referring to FIG. 6, according to an example embodiment, the query information may be query information provided in a safety inspection step that may need to be performed prior to starting to drive a vehicle. According to an example embodiment, the query information may include a question about whether a black box of a vehicle to be driven is normal and may include a question guide for the question. According to an example embodiment, a related image to help a worker understand a question may be stored in advance in relation to the query information. According to an example embodiment, the apparatus 100 may modify and/or store an answer type to query information as having a format such as multiple choice (choose one), multiple choice (choose one or more), and short answer. According to an example embodiment, the apparatus 100 may store information related to an answer in advance. For example, the apparatus 100 may modify and/or store text information (for example, normal/bad), an answer guide (for example, when a power light for a black box is not turned on, it is answered as bad), and an answer guide image (for example, photographing a normal black box or photographing a defective part of the black box), and information on whether to ask an additional question that are related to each of the multiple-choice type answers set to select at least one answer.

Referring to FIG. 7A, according to an example embodiment, the apparatus 100 may display the pre-stored image information as the query information related to each step on a query information display window. For example, when at least one of equipment whose query information is damaged is selected, image information representing each piece of equipment may be displayed along with a question.

Referring to FIG. 7A, according to an example embodiment, an answer guide for an answer that may be selected for query information may include additional information to be provided to a worker in relation to the corresponding answer. For example, what is a normal answer (for example, the correct answer is “no damage”), an instruction to inform a manager when a bumper car is damaged, and information on a request for attachment of an image, video, audio, and the like for the damaged equipment may be provided to a worker who selects an answer that an equipment bumper is damaged through a worker terminal.

According to an example embodiment, when the answer information corresponding to the query information is received, the apparatus 100 may determine not to allow the corresponding job to start according to what the corresponding answer is. According to an example embodiment, the apparatus 100 may be set and stored not to allow the start of the corresponding job for each selected answer. Referring to FIG. 7A, according to an example embodiment, at least one of the answers (for example, damage to a battery connector, damage to a head guard, breakage of an equipment bumper, damage to operating parts such as a handle, a lever, and a button, and the like) that may be selected in response to query information on whether there is damage, such as breakage or a dent, in the equipment may be set in advance to determine that a worker is not allowed to start a job. Therefore, when an answer preset not to allow a job to start is determined as being selected in the answer information from the worker terminal, the apparatus 100 may generate approval information indicating that the start of the job is not allowed and transmit the approval information to the worker terminal.

According to an example embodiment, the apparatus 100 may store a preset answer not to allow a job to start according to an answer for each job, for each step for performing a job, or for each piece of query information on a job. That is, the process that does not allow a job to start may be set not to be performed or conversely may be set to be performed, regardless of the job, the step necessary to perform the job, or what the answer for each piece of query information on the job is.

Referring to FIG. 7B, according to an example embodiment, the apparatus 100 may modify and/or store the query information so that the image related to the answer is displayed as an answer guide image for an answer that may be selected for query information. According to an example embodiment, a worker may determine whether the corresponding answer is a correct answer by referring to the displayed answer guide image and select an answer.

Referring to FIG. 7B, according to an example embodiment, the apparatus 100 may set whether to allow a worker to attach an image when the worker makes an answer in relation to an answer that may be selected for query information. According to an example embodiment, when an answer corresponds to damage to any equipment, a request to add the image information or the like as the answer information for the query information may be provided to the worker through the worker terminal.

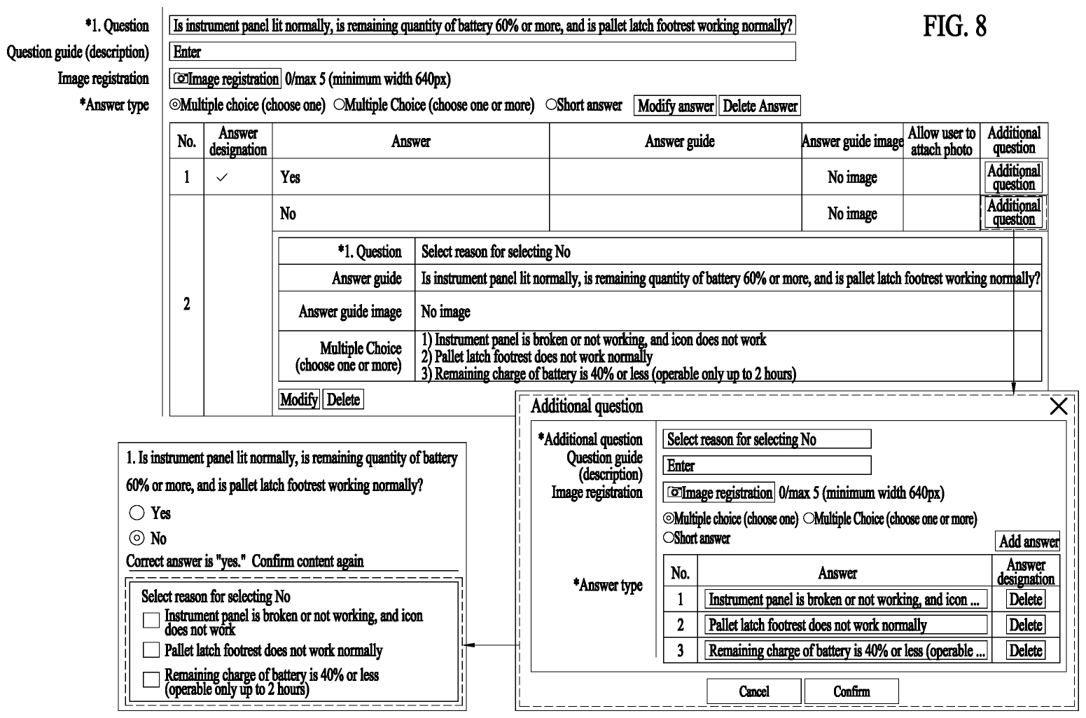

FIG. 8 is a diagram for describing additional query information that may be additionally provided according to answer information of a worker according to an example embodiment.

According to an example embodiment, when the answer information for the query information corresponds to the preset answer information to provide the additional query information to the worker, the apparatus 100 may modify and/or store the additional query information to additionally transmit the additional query information corresponding to the answer to the worker terminal. For example, the apparatus 100 may determine to transmit the additional query information for at least one of the answers that may be selected for the query information to the worker terminal and store the determined additional query information, and the additional query information related to each answer may be different for each answer. For example, referring to FIG. 8, the worker terminal may generate answer information as “yes” or “no” to a query about whether an instrument panel is operating normally, a remaining charge in a battery is 60% or more, and a pallet latch footrest is operating normally and may transmit the generated answer information to the apparatus 100. In this case, the apparatus 100 may not transmit additional query information for the answer information of “yes” to the worker terminal or may transmit additional query information different from the addition query information for the answer information of “no” to the worker terminal while transmitting the additional query information for the answer information of “no” to the worker terminal.

According to an example embodiment, the worker terminal receiving the additional query information may transmit additional answer information generated through answers in various formats, such as text information, image information, video information, and audio information, to the apparatus 100.

According to an example embodiment, the process of modifying and/or storing additional query information by the apparatus 100 may be the same as or similar to the process of modifying and/or storing the above-described query information, and therefore a detailed description thereof will be omitted.

According to an example embodiment, the processor 120 may be further configured to modify at least one of the query information or the predetermined answer information. According to an example embodiment, the query information and/or the predetermined answer information transmitted and received from the transceiver 110 may be modified by the processor 120, and the modified information may be stored in the memory and thus used as the query information to be transmitted later to the worker terminal and the predetermined answer information for comparison with the received answer information to determine whether a worker performs a job in a predetermined manner.

The method according to the present disclosure described above may be provided by being recorded on a computer-readable recording medium as a program for being executed on a computer. The method according to the present disclosure may be implemented as software. When the method is executed as software, the components of the present disclosure are code segments that execute the job. The program or code segments may be stored in a processor-readable medium.

The computer-readable recording medium includes all kinds of recording apparatuses in which data that may be read by a computer system is stored. Examples of the computer-readable recording medium include a ROM, a RAM, a compact disc (CD)-ROM, a digital video disk (DVD)±ROM, a DVD-RAM, a magnetic tape, a floppy disk, a hard disk, an optical data storage device, and the like. In addition, the computer-readable recording medium may be distributed in computer devices connected by a network, and thus the computer-readable codes may be stored and executed in the computer-readable recording medium in a distributed manner.

Since the contents described above may be variously substituted, modified, and altered by those skilled in the art to which the present disclosure pertains without departing from the technical idea of example embodiments, the present disclosure is not limited to the above-described example embodiments and the accompanying drawings.

1. A method operable by an electronic apparatus for facilitating communication regarding a job and an equipment for the job, the method comprising:
receiving, from a terminal of a worker via a network, a first signal indicative of a request by the worker to start a job, the first signal comprising information regarding a state of the equipment for the job scanned by the terminal transmitting, to the terminal via the network, a second signal configured to cause information relating to a query regarding the job to be displayed on a user interface (UI) of the terminal;
receiving, from the terminal via the network, a third signal comprising an answer corresponding to the query;
determining, based on the received answer, that the worker is not allowed to perform the job in a predetermined manner based at least upon the state of the equipment being nonoperable for the job; and
transmitting, to the terminal via the network, in response to determining the worker is not allowed to perform the job in the predetermined manner with the equipment, a fourth signal configured to cause the terminal to request the worker to input new information regarding a state of an alternative equipment for performing the job.

2. The method of claim 1, further comprising:
transmitting approval information indicating whether the worker is to start the job based on the determining whether the worker is allowed to perform the job in a predetermined manner.

3. The method of claim 2, wherein the transmitting of the approval information comprises transmitting the approval information indicating that the worker is not allowed to perform the job if it is determined that the worker is not performing the job in the predetermined manner.

4. The method of claim 2, wherein the determining whether the worker is allowed to perform the job in a predetermined manner comprises determining whether at least one of the received answer information matches predetermined answer information, and
the transmitting of the approval information comprises transmitting the approval information indicating that the worker is not allowed to perform the job based on the at least one of the received answer information matching a predetermined answer.

5. The method of claim 4, further comprising:
modifying at least one of the query or the predetermined answer information.

6. The method of claim 1, wherein the transmitting of the second signal further comprises transmitting the second signal including a request for image information.

7. The method of claim 1, wherein the transmitting of the second signal includes determining at least one of query information to be transmitted from among predetermined query information based on the received job starting information.

8. The method of claim 1, wherein the transmitting of the second signal further includes determining additional query information to be additionally transmitted based on the received answer corresponding to the query.

9. The method of claim 1, wherein the receiving the first signal indicative of a request by the worker to start a job further comprises receiving an identifier of the worker, an identifier of the job, or an identifier of a workplace where the job is performed.

10. An apparatus for allowing a worker to perform a job, the apparatus comprising:
a transceiver configured to:
receive, from a terminal of a worker via a network, a first signal indicative of a request by the worker to start a job, the first signal comprising information regarding a state of the equipment for the job scanned by the terminal,
transmit to the terminal via the network, a second signal configured to cause information relating to a query regarding the job to be displayed on a user interface (UI) of the terminal, and
receive, from the terminal via the network, a third signal comprising an answer corresponding to the query; and
a processor configured to:
determine, based on the received answer, that the worker is not allowed to perform the job in a predetermined manner based at least upon the state of the equipment being nonoperable for the job,
wherein the transceiver is further configured to transmit, to the terminal via the network, in response to determining the worker is not allowed to perform the job in the predetermined manner with the equipment, a fourth signal configured to cause the terminal to request the worker to input new information regarding a state of an alternative equipment for performing the job.

11. The apparatus of claim 10, wherein the transceiver is further configured to transmit approval information indicating whether the worker is to start the job based on the determination whether the worker is allowed to perform the job in a predetermined manner.

12. The apparatus of claim 11, wherein the transceiver is configured to transmit the approval information indicating that the worker is not allowed to perform the job when the worker is not performing the job in the predetermined manner.

13. The apparatus of claim 11, wherein:
the processor further configured to determine whether at least one of the received answer information matches predetermined answer information, and
the transceiver is further configured to transmit the approval information indicating that the worker is not allowed to perform the job when the at least one of the received answer information matches predetermined answer information.

14. The apparatus of claim 13, wherein the processor is further configured to modify at least one of the query or the predetermined answer information.

15. The apparatus of claim 10, wherein the transceiver is further configured to transmit the second signal including a request for image information.

16. The apparatus of claim 10, wherein:
the processor is further configured to determine at least one of query information from among predetermined query information based on the received job starting information, and
the transceiver is further configured transmit the at least one of query information.

17. The apparatus of claim 10, wherein:
the processor is further configured to determine additional query information based on the received answer corresponding to the query, and
the transceiver is further configured to transmit the additional query information.

18. (canceled)

19. A non-transitory computer readable recording medium on which a computer program to execute the method of claim 1 is stored.

20. The method of claim 1, further comprising receiving, from the terminal, a fifth signal indicative of the state of the alternative equipment for the job.

21. The method of claim 20, wherein the fifth signal only comprises information regarding the alternative equipment.
